(19) United States
(12) Patent Application Publication
(10) Pub. No.: US 2005/0194309 A1
(43) Pub. Date: Sep. 8, 2005

(54) Liquid filter, especially an oil filter for an internal combustion engine

(75) Inventors: Michael Harenbrock, Ludwigsburg (DE); Gunnar-Marcel Klein, Spiegelberg (DE)

Correspondence Address: CROWELL & MORING LLP;INTELLECTUAL PROPERTY GROUP, P.O. BOX 14300, WASHINGTON, DC, 20044-4300, US

(73) Assignee: Mann & Hummel GmbH, Ludwigsburg (DE)

(21) Appl. No.: 11/065,484

(22) Filed: Feb. 25, 2005

(30) Foreign Application Priority Data
Feb. 26, 2004 (DE) 10 2004 009 907.3

(51) Int. Cl. B01D 39/14

(52) U.S. Cl. 210/500.1

(57) ABSTRACT

A liquid filter, particularly an oil filter for an internal combustion engine, having a housing with an inlet and an outlet and a filter element sealingly arranged between the inlet and the outlet, in which the filter element includes multiple layers at least one of which serves to separate particles from a liquid stream passing through the filter, and another of which is infused with active substances immobilized therein which chemically decompose and/or physically bind contaminants present in the liquid.

### BACKGROUND OF THE INVENTION

The present invention relates to oil filters and oil filter systems in general. It relates in particular to such filter systems used in filtration of motor oils for internal combustion engines. Specifically, this invention relates to filter systems which include measures for counteracting deterioration in the quality of motor oils during use.

Oil has a number of important functions in an internal combustion engine. The motor oil lubricant reduces friction and thus the wear on metallic components, dissipates heat, seals the combustion chamber and cleans the engine space by dissolving and dispersing impurities. Motor oils become contaminated during operation due to accumulation of combustion particles, foreign substances and abrasion particles. In order for these primary particles not to cause any damage inside the internal combustion engine, e.g., by clogging lubrication gaps and/or by creating secondary wear particles that can reduce engine life, these particles must be removed from the oil circulation system.

The most widely used method of controlling such contamination is to use a full flow filter system. In such a system, the oil conveyed by a pump is passed through a filter before being sent to the individual machine components. This ensures that all the oil will undergo filtration. However, such a full flow system is always a compromise between the ability of the oil to flow through the filter medium and the ability of the filter to retain particles.

In a full flow filter system, particulate contaminants are removed from the oil by deep-bed filtration. The arrangement of fibers in the filter medium results in openings or passages through which the oil can flow. Larger particles are then retained by deposition on the fibers of the deep-bed filter medium, whereas smaller particles can pass through them. Full flow oil filters known at the present time usually achieve 99% removal of particles larger than 40 micrometers in size.

As soon as the fiber density in the filter is increased, it is more difficult for the oil to flow through the filter. When the flow resistance becomes greater, the flow volume and the oil pressure downstream of the filter are reduced. To compensate for this reduction, the surface area of the filter, which is now denser, could be increased. However, to obtain a corresponding pressure drop comparable to that of the conventional full flow systems, while at the same time achieving adequate filtration of particles in the range of 5 to 20 micrometers, the surface area would have to be many times larger. From the standpoint of size and cost, this is generally impractical.

One possibility for improving oil filtration is therefore to provide a second filter system or a partial flow filter system. Partial flow filter systems are used in addition to the existing full flow systems, from which they differ in several regards. First, only a small portion of the output of the oil pump is sent to the partial flow filter. The volume normally amounts to between 5% and 10% of the total amount supplied to the components of the machine. After the oil has passed through the partial flow filter, it is returned to the machine. Due to the fact that the partial flow filter does not process a high flow rate, the density of the filter medium can be much greater. This not only allows an improved efficacy for removal of smaller particles but also frequently allows the removal of other contaminants not retained by conventional full flow filters.

Furthermore, especially in the automotive industry, the trend is toward smaller and smaller filter units because of the limited amount of space available, while at the same time the oil flow rates are increasing. Furthermore, in modern passenger vehicles these oils are exposed to operating conditions that can lead to increased thermal or chemical damage. In addition, statutory requirements for reducing emissions from vehicles have necessitated a reduction in the amounts of additives contained in the oil, which is another problem in addition to the extreme operating conditions cited above.

One major problem with the motor oils used today is that substances which lead to physical and chemical aging of the oil are formed in engine combustion. Contamination is further increased, for example, due to carbon black particles from lean combustion and high exhaust gas recirculation rates, as well as due to longer intervals between oil changes. These substances include reactive chemical compounds such as acids, which are formed from combustion gases and water (e.g., nitrous acid), the oxidation products of the fuel (e.g., organic acids, alcohols, ketones and aldehydes), water, hydroperoxides and their reaction products with one another. These components can cause irreversible damage to the oil, e.g., thickening, so that it is no longer able to fulfill its functions to the required extent. The amount of mobile additives in the oil, i.e., additives in the lubricant circulation, which protect it from damaging reactions and keep contaminants suspended will in the future be reduced due to their contribution to soiling and inactivation of exhaust filters. As a result, these substances can be expected to drastically reduce the chemical lifetime of the filter media.

German patent publication no. DE 101 07 034 describes separation of contaminants from a motor oil by interaction with certain chemicals which physically bind or chemically decompose the contaminants. To do so, the active components are added as bulk material to the filter in a separate container or are bound in the filter medium by impregnation.

### SUMMARY OF THE INVENTION

It is an object of the invention to provide an improved liquid filter.

Another object of the invention is to provide a liquid filter which is particularly suitable for use as an oil filter for an internal combustion engine.

A further object of the invention is to provide a liquid filter which ensure the functional reliability of the liquid to be filtered over the duration of operation.

An additional object of the invention is to provide a liquid filter which can improve the quality of the liquid to be filtered.

These and other objects are achieved in accordance with the present invention by providing a liquid filter comprising a housing with an inlet and an outlet and a filter element interposed in a sealed manner between the inlet and outlet, in which the filter element is comprised of a plurality of layers, at least a first layer of which serves to separate particles from a stream of liquid flowing through the filter, and at least a second layer of which contains at least one active substance that chemically decomposes or physically binds a contaminant present in the liquid, and the at least one active substance is present in an immobilized form in the second layer.

Additional advantageous embodiments and preferred aspects of the invention are described in detail hereinafter.

By analyzing the aging reactions of motor oils, it is possible to identify the compounds formed during driving operation of the motor vehicle that are harmful to the oil. By using substances (=additives) which act chemically or physically in the oil circulation of internal combustion engines and which are capable of chemically decomposing or binding these harmful compounds, it is thus possible to remove from the oil stream the substances that are harmful for the operating liquid and the internal combustion engine. For example, chemically active substances act to decompose harmful substances that are formed in oil such as acid constituents, peroxides, organic nitrates and acids, whereas physically active substances cause the harmful substances to bind or agglomerate so they can be physically retained and removed from the liquid.

The liquid filter of the invention has a housing with at least one inlet and at least one outlet as well as a filter element arranged in a sealed manner between the inlet and outlet. The filter element comprises a filter medium composed of multiple layers, with at least one layer serving the purpose of physical retention or deposition of particles. For example, an organic, synthetic or partially synthetic filter paper or nonwoven filter web can be mentioned here with which deep-bed filtration is performed. In addition to this deposition layer or filter layer, there is another layer which is provided with immobilized active substances for chemical or physical decomposition or binding of pollutants in the oil. The active substances are fixedly bound to the second layer and are preferably uniformly distributed over the entire layer. However, it is also conceivable to increase in the concentration of the active components at certain locations in the active layer to achieve specific local effects within the filter element. The filter element may be constructed with zigzag pleating or some other pleating or as a radial coil and the second active layer may be arranged directly parallel to the filter layer and joined to it or it may be wound as a coil around the zigzag or otherwise pleated filter layer. Preferably, however, the filter layer and active layer have parallel zigzag pleating to thereby offer a large active surface area.

In accordance with one advantageous embodiment of the invention, the active layer is arranged on the upstream side relative to the deposition layer or filter layer. It is thus on the unfiltered liquid side of the filter element. This has the advantage that the contaminants bound and/or decomposed by the active layer can be filtered out by the immediately following filter layer and thus cannot reach the clean side and enter the cleaned oil.

It is advantageous to bond the active substances to the second layer by an adhesive method and then glue or laminate the second layer to the first filter layer. For example, the active substances may be poured onto the layer that has been activated with adhesive, so that only a fraction of the active surface area of the substances is covered with adhesive and thus not rendered ineffective thereby. It is likewise possible to pour an adhesive, e.g., in a fibrous form, onto a layer of bulk material on the substrate layer and thereby create a type of active fiber nonwoven layer.

An alternative approach is to construct the active layer of an at least partially fusible plastic material, which then binds the active components via a melting or fusion process. Here again, it is important to be sure that only a fraction of the active surface area of the active substances is bonded with the resulting melt.

In addition, it is possible to construct the active layer of two fiber nonwoven layers with active substances bonded and arranged between them. This yields the advantage of being able to immobilize a larger quantity of active substances without having to fear that the substances will be dissolved out in high through-flows.

In accordance with another advantageous embodiment of the invention, the substances used as active substances for binding and decomposing contaminants materials of the type used as carrier materials in chromatography, e.g., silica gel, diatomaceous earth, calcium carbonate and aluminum oxide. It is also possible to use substances such as zeolites that render pollutants harmless by adsorption and subsequent decomposition via acidic or basic functional groups. For example, calcium carbonate is added to high-grade oils to prevent aging due to formation of acid in the oil. However, this results in formation of calcium oxide in ash form in the combustion process, which can have negative effects for the exhaust aftertreatment in particular due to deposits. By immobilizing calcium carbonate in the active layer, it is now possible to utilize the positive functions of this substance without the disadvantages which occur due to transport through the motor oil into the means provided for exhaust aftertreatment, e.g., diesel particle filters. In addition, this makes it possible to decrease the calcium carbonate concentration in the oil.

In accordance with an alternative embodiment of the invention, the active substances comprise substances having basic and/or amphoteric functional groups. Here again, acids that are formed in the oil are neutralized, with the amphoteric substances offering the possibility of binding and/or decomposing both basic and acidic compounds.

Examples of the substances mentioned above for use as active substances consisting of inorganic compounds include metal oxides, hydroxides, bicarbonates, carbonates, alcoholates, carboxylates and other substances with which persons skilled in the art are familiar.

As an alternative to this, the active substances containing basic and/or amphoteric functional groups may comprise organic compounds such as amines, alcoholates, carboxylates and other substances with which persons skilled in the art are familiar.

According to another alternative, the composition of the active substances may suitably include catalytically active substances such as metals and metal compounds, e.g., metal oxides. The catalytically active substances drastically decrease the activation energy for the start of a decomposition process and are recovered from the reaction unchanged. The choice of substance is based on considerations of chemical stability of the pollutants to be destroyed.

The catalytically active substances may preferably comprise metal or metal oxide compounds because they are easy to process and their application is also simple.

In accordance with yet another advantageous embodiment of the invention, the liquid filter of the invention may be arranged in the full flow and/or a partial flow of an oil circuit. Specifically, the arrangement in a partial flow filter has the advantage of leaving the flow properties of the main filter unaffected and allowing the decomposition and binding of contaminants to be carried out in the partial flow filter, where a slight increase in the pressure difference between the unfiltered liquid side and the clean side does not have an adverse effect on the system as a whole. A metal oxide immobilized between two tacky fiber nonwoven layers is advantageously used as the active substance. This active layer is then permanently joined to a filter layer of the zigzag pleated filter element on upstream side and is then arranged in the full flow and/or in a partial flow. The metal oxide then reacts with harmful acid present in the oil to form harmless immobilized metal salt.

In an alternative embodiment of the inventive approach described here as a two-layer material, the active components may also be bonded in the physically active filtration layer. The prerequisite for this is that the filtration efficiency is not impaired to an unacceptable extent with respect to the degree of separation and in particular with respect to mechanical stability. Furthermore, it is necessary to ensure by binding to the fiber matrix that the active component is permanently bound to the bulk fiber material and thus cannot be washed out during use. Approaches according to this invention thus include admixtures of active inorganic fibers and spherical active particles which are permanently joined to the fibers by impregnation, optionally by covalent bonding via chemical groups as described, for example, in German patent publication no. DE 101 07 034.

These and other features of preferred embodiments of the invention, in addition to being set forth in the claims, are also disclosed in the specification and/or the drawings, and the individual features each may be implemented in embodiments of the invention either individually or in the form of subcombinations of two or more features and can be applied to other fields of use and may constitute advantageous, separately protectable constructions for which protection is also claimed.

### BRIEF DESCRIPTION OF THE DRAWINGS

The invention will be described in further detail hereinafter with reference to illustrative preferred embodiments shown in the accompanying drawing figures, in which:

FIG. 1 is a schematic representation of a liquid filter according to the invention; and

FIG. 2 is a schematic diagram depicting an oil circuit with a liquid filters according to the invention arranged in a full flow stream and in a partial flow stream.

### DETAILED DESCRIPTION OF PREFERRED EMBODIMENTS

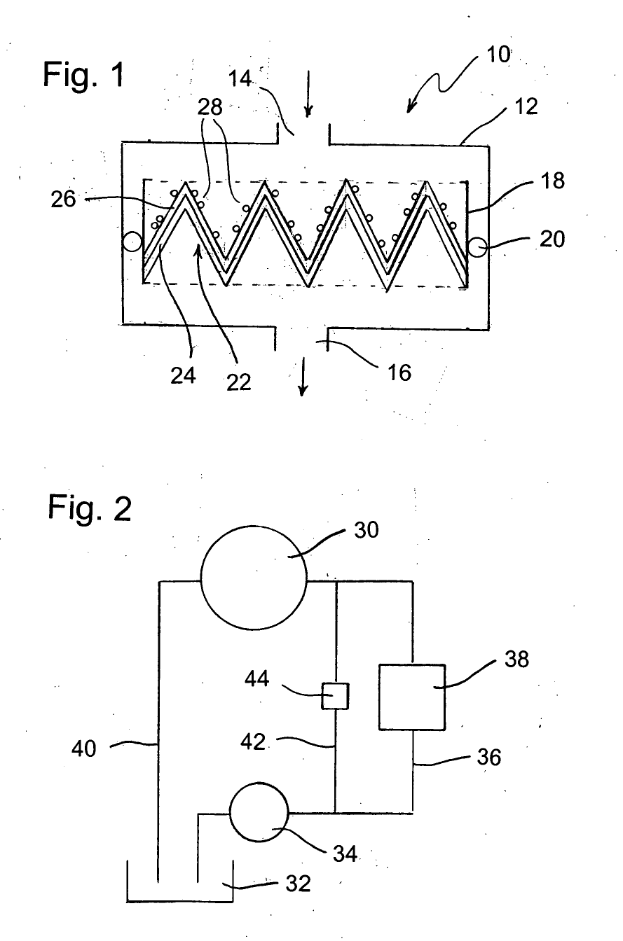

FIG. 1 is a schematic representation of a liquid filter 10 comprising a housing 12 with a liquid inlet 14 and a liquid outlet 16. A filter element 18 surrounded by a resilient seal member 20 is sealingly interposed in housing 12 between the inlet 14 and the outlet 16. Filter element 18 is comprised of a multi-layer filter material 22 including a first layer 24, which acts as a particle separating filter layer, and a second layer 26, which is positioned upstream of first layer 24 in the direction of flow of a liquid passing through filter 10. Second layer 26 contains active substance particles 28 which chemically decompose and/or physically bind contaminants present in the liquid. The active substance particles 28 are permanently immobilized on filter layer 26, e.g. by adhesive bonding or by fusion bonding.

FIG. 2 is a schematic illustration of an oil circuit for an internal combustion engine shown symbolically at 30. Oil from an oil pan 32 is drawn by a pump 34 and pumped through a line 36 to the engine 30. The oil traversing line 36 passes through a multi-layer filter 38 constructed according to the present invention in which particles are separated out and contaminants are decomposed and/or bound. Oil from engine 30 is returned to the oil pan 32 through a return line 40.

If desired, a partial stream of the oil, amounting to from about 5% to about 10% of the total flow, may be diverted from line 36 through a partial flow line 42 on which a partial flow filter 44 constructed according to the present invention is disposed.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

1. A liquid filter comprising a housing with an inlet and an outlet and a filter element interposed in a sealed manner between the inlet and outlet, wherein the filter element is comprised of a plurality of layers, at least a first layer of which serves to separate particles from a stream of liquid flowing through the filter, and at least a second layer of which contains at least one active substance that chemically decomposes or physically binds a contaminant present in the liquid, wherein said at least one active substance is present in an immobilized form in said second layer.

2. A liquid filter according to claim 1, wherein said filter is an oil filter connected to a lubricating oil circuit of an internal combustion engine.

3. A liquid filter according to claim 1, wherein the second layer is arranged upstream of said first layer in the direction of flow of the stream of liquid flowing through the filter.

4. A liquid filter according to claim 1, wherein the at least one active substance is permanently bonded to said second layer by adhesive bonding.

5. A liquid filter according to claim 1, wherein the at least one active substance is permanently bonded to said second layer by fusion to said second layer.

6. A liquid filter according to claim 1, wherein said second layer comprises two fiber nonwoven sublayers with the at least one active substance permanently trapped between the two sublayers.

7. A liquid filter according to claim 1, wherein said at least one active substance is selected from the group consisting of silica gel, diatomaceous earth, calcium carbonate, zeolites and aluminum oxide.

8. A liquid filter according to claim 1, wherein said at least one active substance is a substance having basic or amphoteric functional groups.

9. A liquid filter according to claim 8, wherein the at least one active substance is an inorganic compound selected from the group consisting of metal oxides, hydroxides, bicarbonates, carbonates, alcoholates, and carboxylates.

10. A liquid filter according to claim 8, wherein the at least one active substance is an organic compound selected from the group consisting of amines, alcoholates and carboxylates.

11. A liquid filter according to claim 1, wherein the at least one active substance is a catalytically active substance.

12. A liquid filter according to claim 11, wherein said catalytically active substance comprises a metal or metal compound.

13. A liquid filter according to claim 2, wherein said filter is situated in a partial flow stream of the lubricating oil.

14. A liquid filter according to claim 2, wherein said filter is situated in a full flow stream of the lubricating oil.

15. A liquid filter according to claim 1, wherein the first and second filter layers are combined to form a single filter material.
